(19) United States
(12) Patent Application Publication
(10) Pub. No.: US 2008/0143737 A1
(43) Pub. Date: Jun. 19, 2008

(54) Post-Render Graphics Transparency

(75) Inventors: Steven Todd Weybrew, Portland, OR (US); Simon Wilson, Dacono, CO (US); Brian Ellis, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/955,239

(22) Filed: Dec. 12, 2007

Related U.S. Application Data
(60) Provisional application No. 60/870,361, filed on Dec. 15, 2006.

(51) Int. Cl. G09G 5/02

(52) U.S. Cl. 345/592

(57) ABSTRACT

An apparatus, method, and computer program product for applying transparency to a rendered surface. The apparatus comprises a graphics processor configured to render a surface, wherein a transparency parameter is associated with the surface, the transparency parameter defining a blending process. The apparatus further includes a display processor configured to blend the rendered surface in accordance with the transparency parameter. Preferably, the transparency parameter is an EGL surface attribute.

### RELATED APPLICATIONS

This application claims the benefit of provisional U.S. Application Ser. No. 60/870,361 filed Dec. 15, 2006, which is incorporated by reference herein.

### TECHNICAL FIELD

This disclosure relates to graphics processing, and more particularly, relates to the application of transparency to surfaces after a rendering process.

### BACKGROUND

Modern user interfaces (UIs) use effects like surface transparency to improve the usability or “look and feel” of the environment or certain operations. One example of the use of transparency is the repositioning of a window. As the window is moved, the window becomes transparent and both the window and the background behind the window may be seen. The Embedded-System Graphics Library (EGL) specification does not provide a method to specify 3D surface transparency other than color-keying. As such, content providers and creators have to be aware of the required color to achieve the desired transparency. Also, since no alpha blending is supported while posting the surface to the display (e.g. eglSwapbuffers), it's an all or none model.

### SUMMARY

In view of the foregoing, this disclosure presents methods, apparatuses, and computer program products that enable content independent surface transparency and the blending of the surfaces, including 3D surfaces, with the other content of a display using constant or per-pixel alpha to achieve partial transparency.

According to one embodiment, the apparatus comprises a graphics processor configured to render a surface, wherein a transparency parameter is associated with the surface, the transparency parameter defining a blending process. The apparatus further includes a display processor configured to blend the rendered surface in accordance with the transparency parameter. Preferably, the transparency parameter is an EGL surface attribute.

The details of one or more embodiments are set forth in the accompanying drawings and the description below. Other features, objects, and advantages of the invention will be apparent from the description and drawings, and from the claims.

### BRIEF DESCRIPTION OF DRAWINGS

FIG. 1. is a block diagram of a GPU and a display processor.

FIG. 2 is a flowchart of a method for applying a transparency scheme and level to a surface.

FIG. 3 is a block diagram of a GPU and a display processor in a mobile device.

FIG. 4 is a flowchart of a method for applying a transparency scheme and level to a surface.

FIG. 5 shows attributes for an EGL surface including transparency parameters

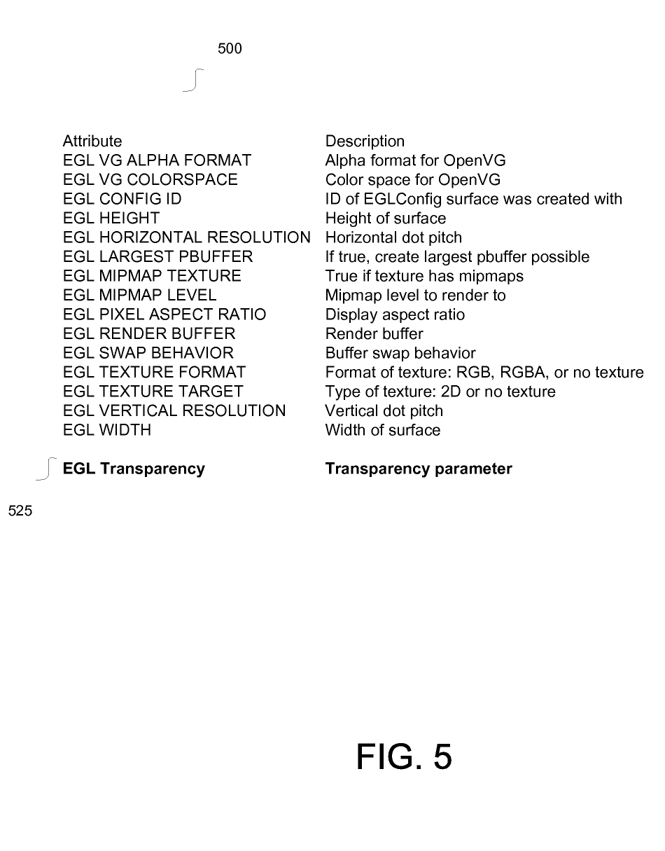

### DETAILED DESCRIPTION

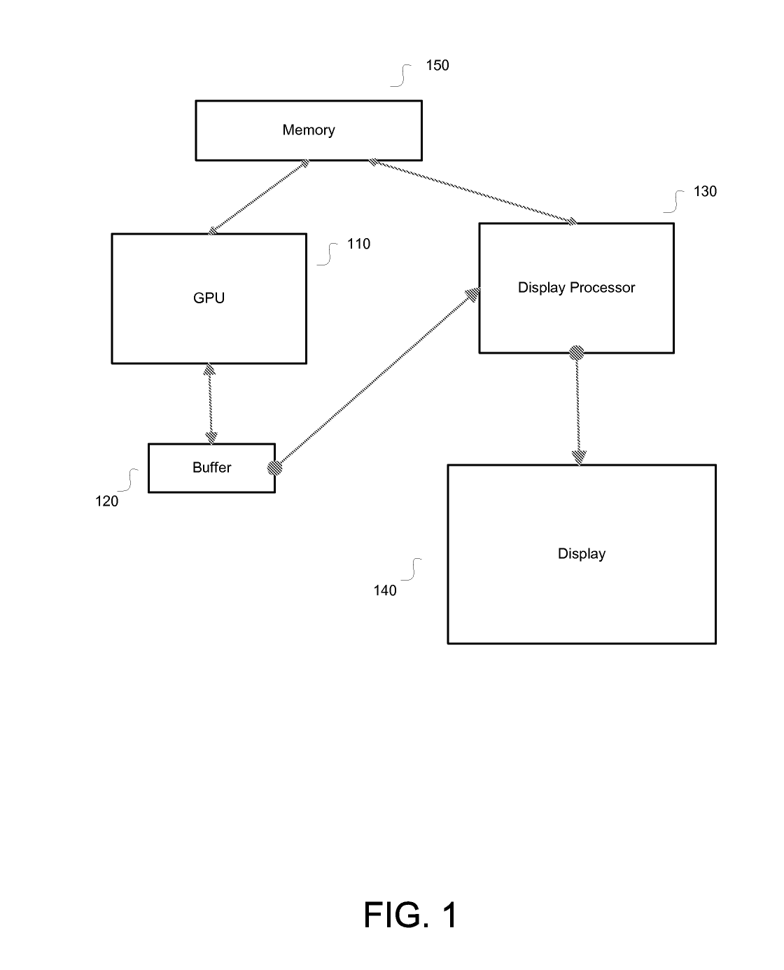

FIG. 1 shows a block diagram of a GPU and a display processor. A graphics processing unit (GPU) is a dedicated graphics rendering device utilized to render, manipulate and display computerized graphics. GPUs are typically built with a highly parallel structure that provides more efficient processing than typical, general purpose central processing units (CPUs) for a range of complex graphics-related algorithms. For example, the complex algorithms may correspond to representations of three-dimensional computerized graphics. A GPU may implement a number of so-called “primitive” graphics operations, such as forming points, lines, and triangles, to create complex, three-dimensional images on a display more quickly than drawing the images directly to the display with a CPU.

GPU 110 is a graphics processor used for rendering a graphics frame for eventual display. For this disclosure, the term render refers to both 3D and 2D rendering. As examples, GPU 110 may utilize Open Graphics Library (OpenGL) instructions to render 3D graphics frames, or may utilize Open Vector Graphics (OpenVG) instructions to render 2D graphics frames. However, any standards, methods, or techniques for rendering graphics may be utilized by GPU 110.

GPU 110 may carry out instructions that are stored in memory 150. Memory 150 may include any permanent or volatile memory capable of storing instructions. In addition, GPU 110 may execute instructions that are received over an air interface (e.g., CDMA 1×, EV-DO, WiFi). Surfaces rendered by GPU 110 are stored in buffer 120. Buffer 120 may be any permanent or volatile memory capable of storing data. A user program that employs GPU 110 may select a desired transparency scheme and level to be applied to the rendered surface. For the purposes of this disclosure a transparency “level” is defined as a constant alpha value, a per-pixel alpha value or a linear combination (i.e., multiplication) thereof. The selected transparency scheme and levels are stored in memory 150 for use by display processor 130. Examples of possible transparency schemes include constant alpha transparency and per-pixel alpha transparency. However, any transparency scheme may be employed.

In particular, the transparency scheme may be stored as a parameter associated with a surface that is to be rendered and displayed. As one example, this parameter may be an attribute included in an Embedded-System Graphics Library (EGL™) description of the surface. EGL is an interface between APIs such as OpenGL ES or OpenVG and an underlying native platform window system. In this way, third-party developers of applications may define a surface transparency using a familiar programming language without having to develop separate commands for instructing a particular display processor to perform a blending process. FIG. 8 shows an example of EGL surface attributes 500 including the transparency parameter 525.

Transparency parameter 525 in EGL surface attributes 500 allows specification of a single alpha value to support constant alpha blending of a rendered surface, including a 3D rendered surface, with the other contents of a display while the MDP is transferring the rendered surface to the actual display. Alternatively, this transparency parameter may enable per-pixel blending of a rendered surface with the existing display contents using either the alpha channel of the rendered surface or a separate pre-stored or dynamically computed alpha map. In addition, this transparency parameter may enable per-pixel blending of a rendered surface with the existing display contents using either the alpha channel of the rendered surface or a separate pre-stored or dynamically computed alpha map combined with a constant alpha value. Use of EGL surface attributes allows a user program (or a window manager) to specify surface transparency in one of several modes. Providing support for more transparency schemes allows more flexibility than the simple color-keying supported by EGL, allowing modern UI effects while not requiring specific colors in the application content.

Constant alpha transparency and per-pixel alpha transparency are both examples alpha blending. Alpha blending refers to the technique of combining an image (e.g., a rendered surface) with a background to create the appearance of partial transparency. The degree or level to which pixels in a rendered surface are to be blended is stored in the alpha channel. The alpha channel accompanies the RGB values for each pixel. Typically, alpha channel values range from 0 (fully transparent) to 255 (fully opaque). However, any range or precision of alpha may be employed. A rendered surface pixel that has an alpha of 0 will be fully transparent, and thus the color of the pixel in the background will be displayed and the color of the rendered surface pixel will not be seen. Conversely, a rendered surface pixel that has an alpha of 255 will be fully opaque and the pixel in the background image will not be seen. For alpha values in between 0 and 255, the color values of the rendered graphics pixels and the background image pixels are independently scaled and added together in a linear fashion.

One common technique for alpha blending was described by Porter and Duff at Thomas Porter and Tom Duff, Compositing Digital Images, Computer Graphics, 18(3), July 1984, 253-259. Their equation is below:

r=k₁s+k₂d

r=result

s=source pixel

d=existing destination pixel (background pixel)

k₁=alpha OR 1-alpha

k₂=1-alpha OR alpha

Most commonly, the result of blending a source pixel with a destination pixel (e.g., the background pixel) is achieved by scaling the source pixel by an alpha value and adding it to the destination pixel that is scaled by (1-alpha). Conversely, the source pixel may be scaled by (1-alpha) and the destination pixel may be scaled by alpha. The k₁ and k₂ variables may be any values, but are typically designed so that k₁+k₂=1, as in the example above. If the sum of k1 and k2 is greater than 1, a non-unity gain would occur and the brightness of the image would be increased. Likewise, if the addition of k1 to k2 is less than one, the brightness of the image would decrease.

In constant alpha transparency, the same alpha level is applied to all the pixels in a rendered surface. In per-pixel alpha transparency, each pixel in a rendered graphics may be given its own alpha level. When both a constant alpha value and alpha map are specified, the per-pixel alpha retrieved from the alpha map is scaled (i.e., multiplied) by the constant alpha value to determine the effective alpha value.

Returning to FIG. 1, display processor 130 is a processor for driving display 140 (i.e., sending the pixel color values to the display), and for performing post-rendering processes on the rendered surface. Display processor 130 may be any type of processor. As one example, display processor 130 may be a Mobile Display Processor (MDP) embedded in Mobile Station Modems designed by Qualcomm, Inc. of San Diego, Calif. An MDP is a processor that has been dedicated to and optimized for driving a display and performing post-render functions on a rendered surface. Such function may include scaling, rotation, and transparency. Display processor 130 may be constructed to execute instructions stored in memory 150.

When GPU 110 has rendered a surface and stored it in buffer 120, display processor 130 retrieves the rendered surface from buffer 120 and applies the selected transparency scheme and level to rendered surface. The transparency scheme and levels may be obtained from memory 150. By using a different processor for the application of transparency schemes and levels, processing overhead is saved for the GPU. In addition, complex multi-pass window manager algorithms and frequent graphics hardware pipeline context changes are avoided.

When using per-pixel alpha transparency, the level selected by user program may point to pre-stored alpha maps rather than dynamically computing alpha levels for each pixel in the rendered surface. Such alpha maps may define commonly used transparency schemes. For instance, an alpha map for an irregular window border may be pre-stored. As one example, all pixels outside a border shape may be assigned a fully transparent alpha level, while all pixels inside a border shape may be assigned a fully opaque alpha level. However, selection of pre-stored alpha maps when using per-pixel alpha transparency is not required. Individual alpha values for each pixel may be generated as desired.

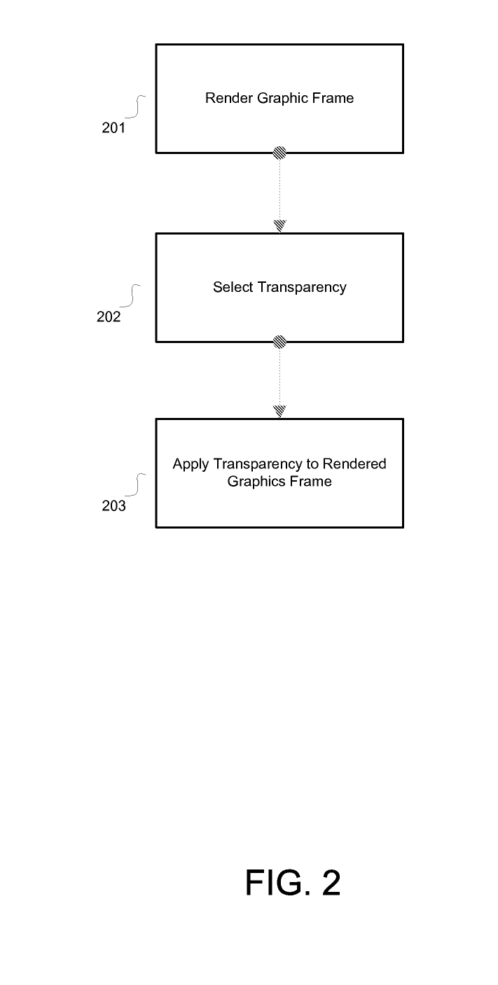

FIG. 2 is a flowchart of a method for applying a transparency scheme and level to a surface. In step 201, a surface is rendered. In step 202, a transparency scheme and level is selected. Then in step 203, the selected transparency scheme and level is applied to the rendered surface.

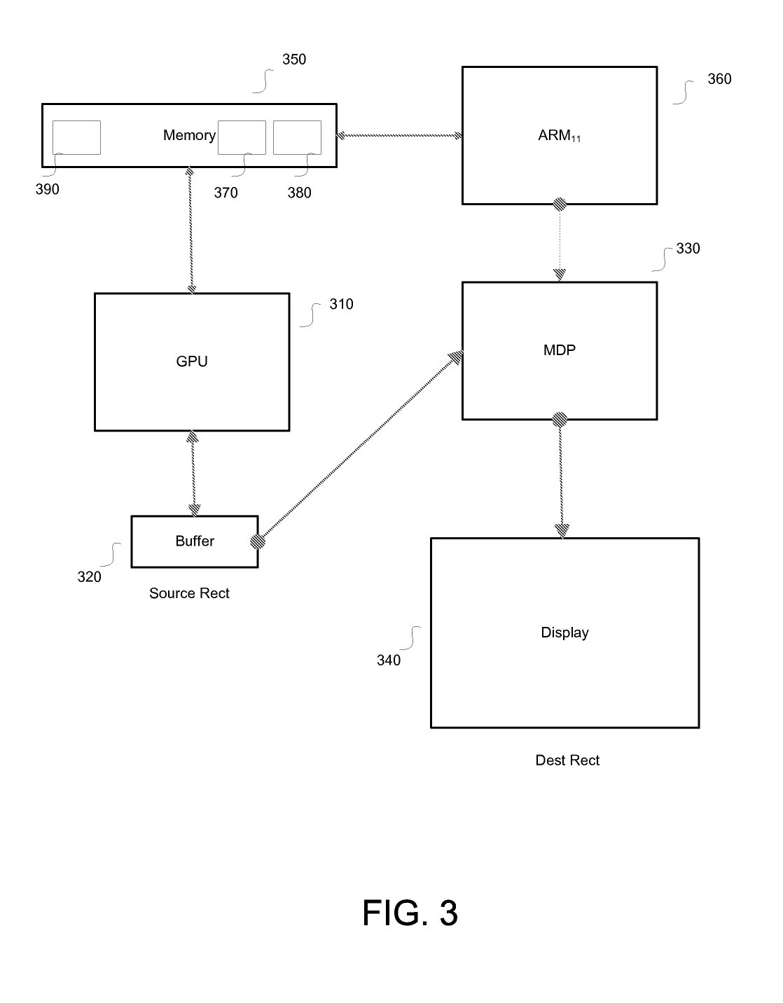

FIG. 3 is a block diagram of a GPU and a display processor in a mobile device. GPU 310 executes instructions from user program 390 stored in memory 350. As an example, GPU 310 may be an Imageon 7 series GPU made by Advanced Micro Devices, Inc. of Sunnyvale, Calif. Memory 350 may be implemented as Flash random access memory (RAM). User program 390 may be any program that utilizes GPU 310. For example, user program 390 may be a video game. GPU 310 executes instructions from user program 390 and renders surfaces to be displayed into buffer 320. Buffer 320 may be synchronous dynamic RAM (SDRAM). User program 390 may be configured to establish connection to display 340 and/or determine system parameters in order to determine transparency schemes and levels to be applied to rendered surface. Such system parameters may be stored in memory 350. Once the transparency scheme and level have been selected by user program 390, user program 390 stores the scheme and level as control parameters 370 in memory 350.

Memory 350 may also be used to store Application Programming Interface (API) 380. API 380 serves as the conduit between user program 390 and MDP 330. When GPU 310 has rendered a surface to buffer 320, user program 390 may execute an instruction to display that surface. Such a display instruction may be a function that calls API 380. API 380 then instructs control processor 360 to control MDP 330 to apply the selected transparency scheme and level (stored as control parameters 370) to the rendered surface in buffer 320. Control processor 360 may be an Advanced RISC (reduced instruction set computer) Machine (ARM) processor such as the ARM₁₁ processor embedded in Mobile Station Modems designed by Qualcomm, Inc. of San Diego, Calif. MDP 330 may be a mobile display processor embedded in Mobile Station Modems designed by Qualcomm, Inc. of San Diego, Calif. MDP 330 retrieves the rendered surface from buffer 320, applies the selected transparency scheme and level to the rendered surface, and drives display 340 to display the resultant rendered surface with applied transparencies.

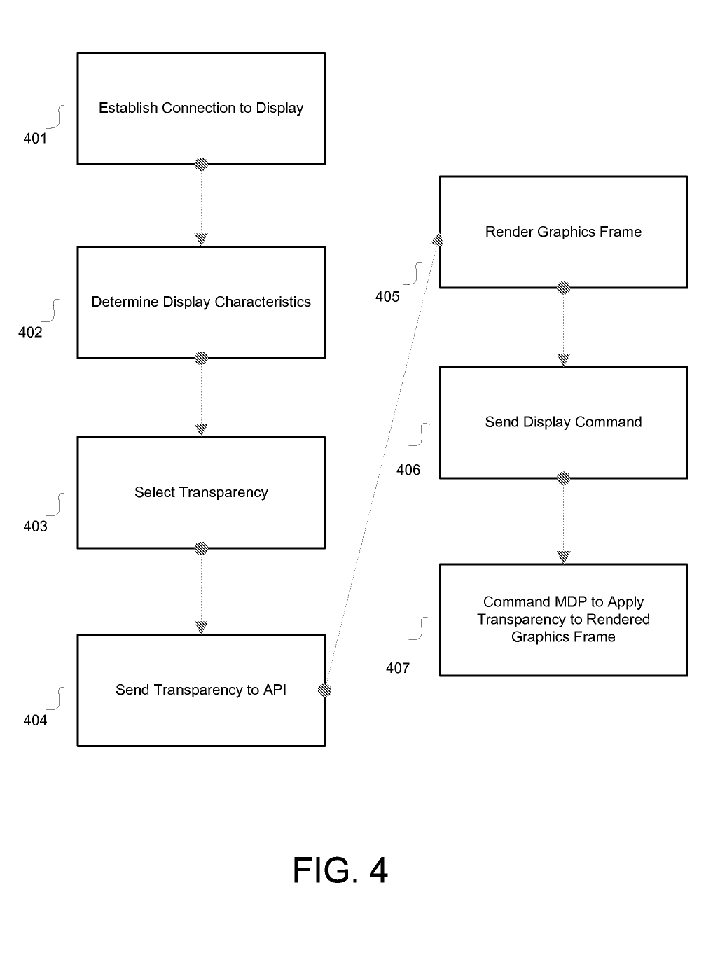

FIG. 4 is a flowchart of a method for applying a transparency scheme and level to a surface. In step 401, a connection to a display is established. Then in step 402, the characteristics of the display are determined. Such characteristics may be determined from data previously stored in memory, or through direct communication with the display. In step 403, a transparency scheme and level are selected. In step 404, the selected transparency scheme and level are sent to or made available to an API. In step 405, a surface is rendered. In step 406, a display command (e.g., eglSwapBuffers) is sent to the API. In step 407, the API sends a command to an MDP to apply the selected transparency scheme and level to the rendered surface.

The apparatuses, methods, and computer program products described above may be employed various types of devices, such as a wireless phone, a cellular phone, a laptop computer, a wireless multimedia device (e.g., a portable video player or portable video gaming device), a wireless communication personal computer (PC) card, a personal digital assistant (PDA), an external or internal modem, or any device that communicates through a wireless channel.

Such devices may have various names, such as access terminal (AT), access unit, subscriber unit, mobile station, mobile device, mobile unit, mobile phone, mobile, remote station, remote terminal, remote unit, user device, user equipment, handheld device, etc.

Any device described above may have a dedicated memory for storing instructions and data, as well as dedicated hardware, software, firmware, or combinations thereof. If implemented in software, the techniques may be embodied as instructions on a computer-readable medium, such as random access memory (RAM), read-only memory (ROM), non-volatile random access memory (NVRAM), electrically erasable programmable read-only memory (EEPROM), FLASH memory, magnetic or optical data storage device, or the like, executable by one or more processors. The instructions cause one or more processors to perform certain aspects of the functionality described in this disclosure.

The techniques described in this disclosure may be implemented within a general purpose microprocessor, digital signal processor (DSP), application specific integrated circuit (ASIC), field programmable gate array (FPGA), or other equivalent logic devices. Accordingly, components described as modules may form programmable features of such a process, or a separate process.

Various embodiments described herein may be combined in whole or in part. These and other embodiments are within the scope of the following claims.

1. An apparatus for processing graphics comprising:
a graphics processor configured to render a surface, wherein a transparency parameter is associated with the surface, the transparency parameter defining a blending process; and
a display processor configured to blend the rendered surface in accordance with the transparency parameter.

2. The apparatus of claim 1, where in the transparency parameter is an EGL surface attribute.

3. The apparatus of claim 1, wherein the transparency parameter defines a constant alpha blending process.

4. The apparatus of claim 1, wherein the transparency parameter defines a per-pixel alpha blending process.

5. The apparatus of claim 1, wherein the transparency parameter defines both a constant alpha blending process and a per-pixel alpha blending process.

6. The apparatus of claim 1, further including:
a memory configured to store the transparency parameter; and
a control processor configured to instruct the display processor to blend the rendered surface in accordance with the transparency parameter.

7. An apparatus for processing graphics comprising:
means for rendering a surface, wherein a transparency parameter is associated with the surface, the transparency parameter defining a blending process; and
blending means for blending the rendered surface in accordance with the transparency parameter.

8. The apparatus of claim 7, where in the transparency parameter is an EGL surface attribute.

9. The apparatus of claim 7, wherein the transparency parameter defines a constant alpha blending process.

10. The apparatus of claim 7, wherein the transparency parameter defines a per-pixel alpha blending process.

11. The apparatus of claim 7, wherein the transparency parameter defines both a constant alpha blending process and a per-pixel alpha blending process.

12. The apparatus of claim 7, further including:
means for storing the transparency parameter; and
means for instructing the blending means to blend the rendered surface in accordance with the transparency parameter.

13. A method for rotating a rendered surface comprising:
rendering a surface;
selecting a transparency scheme; and
blending the rendered surface in accordance with the transparency scheme.

14. The method of claim 13, w herein the selected transparency scheme is associated with the surface through EGL surface attributes.

15. The method of claim 13, wherein the transparency scheme is defined by a constant alpha blending process.

16. The method of claim 13, wherein the transparency scheme is defined by a per-pixel alpha blending process.

17. The method of claim 13, wherein the transparency scheme is defined by both a constant alpha blending process and a per-pixel alpha blending process.

18. The method of claim 13, further including:
establishing a connection to a display;
determining display characteristics;
sending the transparency scheme to an API;
sending a display command; and
sending a command instructing a display processor to perform the blending step.

19. A computer-readable medium storing computer-executable instructions for rotating a rendered surface, the computer-executable instructions comprising:
code for causing a computer to render a surface;
code for causing a computer to select a transparency scheme; and
code for causing a computer to blend the rendered surface in accordance with the selected transparency scheme.

20. The computer-readable medium of claim 19, wherein the selected transparency scheme is associated with the surface through EGL surface attributes.

21. The computer-readable medium of claim 19, wherein the transparency scheme is defined by a constant alpha blending process.

22. The computer-readable medium of claim 19, wherein the transparency scheme is defined by a per-pixel alpha blending process.

23. The computer-readable medium of claim 19, wherein the transparency scheme is defined by both a constant alpha blending process and a per-pixel alpha blending process.

24. The computer-readable medium of claim 19, further including:
code for causing a computer to establish a connection to a display;
code for causing a computer to determine display characteristics;
code for causing a computer to send the transparency scheme to an API;
code for causing a computer to send a display command; and
code for causing a computer to send a command instructing a display processor to perform the blending step.
